(19) United States
(12) Patent Application Publication
(10) Pub. No.: US 2009/0127315 A1
(43) Pub. Date: May 21, 2009

(54) APPARATUS AND METHOD FOR MANUFACTURING SEMICONDUCTOR DEVICE

(75) Inventor: Takanori OKITA, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/255,941

(22) Filed: Oct. 22, 2008

(30) Foreign Application Priority Data
Nov. 16, 2007 (JP) 2007-298500

(51) Int. Cl. B23K 37/04; B65G 35/00

(52) U.S. Cl. 228/102; 228/9; 228/213; 228/212; 414/806

(57) ABSTRACT

An apparatus for manufacturing a semiconductor device is provided. The apparatus has a bonding head, a stage, and a system for appropriately setting the amount of a descending movement of the bonding head. The bonding head incorporates a heater. A camera is capable of capturing an image of a gap between the bonding head and the stage under the condition that the bonding head holds a first bonding object and the stage has a second bonding object mounted thereon and before the first and second bonding objects come in contact with each other. A controller calculates the amount of the descending movement of the bonding head based on the image captured by the camera, and causes the bonding head to descend based on the calculated amount of the descending movement.

### FIELD OF THE INVENTION

The present invention relates to an apparatus and method for manufacturing a semiconductor device.

### BACKGROUND ART

It is known that a conventional apparatus for manufacturing a semiconductor device includes a stage and a bonding head, which have respective heaters therein, as disclosed in JP-A-2006-73873. In the apparatus, the bonding head first holds a semiconductor chip having a bump, and a substrate is mounted on the stage. The bonding head then moves toward the stage such that the bump of the semiconductor chip comes in contact with the substrate. After this arrangement is completed, heating temperatures of the heaters increase to melt the bump.

In the technique disclosed in JP-A-2006-73873, the heating temperatures of the heaters are lowered except when the bump is melted after the abovementioned arrangement is completed. For example, the heating temperatures of the heaters are sufficiently lowered than the melting point of the bump when the bonding head receives a semiconductor chip at the start of each process, and when the bonding head moves toward the stage, and during descent of the bonding head.

On the other hand, a technique for manufacturing a semiconductor device for a reduced time has been expected from the perspective of high productivity. It is, however, difficult that the technique disclosed in JP-A-2006-73873 reduces the time required to manufacture a semiconductor device. Specifically, in the technique described in JP-A-2006-73873, after the semiconductor chip and the substrate are positioned, the heating temperatures of the heaters start increasing. In order to increase or decrease the temperatures of the heaters, it takes a certain time to adjust the heating temperatures of the heaters. In the technique described in JP-A-2006-73873, a time required to bond the semiconductor chip to the substrate by melting the bump after the positioning of the semiconductor chip and the substrate is equal to or longer than the time required to adjust the heating temperatures of the heaters.

Techniques disclosed in JP-A-2005-259925 and in JP-A-H09-92682 have been proposed to solve the abovementioned problem. In each of the techniques described in JP-A-2005-259925 and in JP-A-H09-92682, a heater provided on the side of a bonding head melts a bump of a semiconductor chip held by the bonding head, thereafter the semiconductor chip having the melted bump is bonded to the substrate. In each of the techniques described in JP-A-2005-259925 and in JP-A-H09-92682, the bump is melted before the semiconductor chip comes in contact with the substrate. Therefore, a time required to increase a heating temperature of the heater for bonding of the semiconductor chip and the substrate in each of the techniques described in JP-A-2005-259925 and in JP-A-H09-92682 can be reduced compared with the technique described in JP-A-2006-73873 in which the heating temperature of the heater increases after the semiconductor chip and the substrate are positioned. As a result, a time required for the bonding process can be reduced.

Patent document 1: JP-A-2006-73873

Patent document 2: JP-A-2005-259925

Patent document 3: JP-A-H09-92682

### SUMMARY OF THE INVENTION

It is preferable that the position of the bonding head be accurately controlled before the semiconductor chip and the substrate are bonded to each other. In other words, it is preferable that the following amount be appropriately set: the amount of the displacement (descending movement) of the bonding head toward the stage from the position of the bonding head in the state where the bonding head holds the semiconductor chip and the substrate is mounted on the stage. The reason is described as follows. That is, it is desirable that the thicknesses of semiconductor chips having the same specifications be constant, the thicknesses of substrates having the same specifications be constant, and the heights of the solder bumps having the same specifications be constant. However, those dimensions actually vary within their tolerance limits. Therefore, the optimal distance between the bonding head and the stage during the bonding varies in each bonding process. In the case where the distance between the bonding head and the stage is fixed to a certain value during the bonding, even when a bump of a semiconductor chip and a bump of a substrate appropriately come in contact with each other in an appropriate manner, a bump of another semiconductor chip and a bump of another substrate may come too close to each other.

In the technique described in JP-A-2006-73873 in which the bumps are melted after the semiconductor chip and the substrate come in contact with each other, a contact detection technique using a load cell can be used (the contact detection technique is described in JP-A-2006-73873). In the contact detection technique, since the load cell is provided on the side of the bonding head, the load cell is capable of detecting a load generated by the contact of the bump of the semiconductor chip with the bump of the substrate during the descent of the bonding head. When the load is detected, it can be determined that the semiconductor chip and the substrate are in contact with each other via the bumps.

When the contact detection technique is used in the techniques described in JP-A-2005-259925 and in JP-A-H09-92682, the following problem may arise. That is, it is difficult to detect a load generated by the contact of the bump of the semiconductor chip with the bump of the substrate under the condition that the bumps are melted, since the load is significantly small. Therefore, even when the contact detection technique is used in the techniques described in JP-A-2005-259925 and in JP-A-H09-92682, it is difficult to stop the movement of the bonding head at an appropriate position. In order to solve the abovementioned problems, the present inventor devised another method for appropriately controlling an operation of the bonding head through intense study.

It is, therefore, an object of the present invention to provide an apparatus and method for manufacturing a semiconductor device, which are capable of appropriately controlling an operation of a bonding head and the like to perform bonding.

Another object and advantage of the invention, and another object and advantage of another invention included in the present application, are apparent from the following description.

According to an aspect of the present invention, an apparatus for manufacturing a semiconductor device has a bonding head, a stage, a camera, and a controller. The controller is connected with the bonding head, the stage, and the camera. The camera is capable of capturing an image of a gap between the bonding head and the stage under the condition that the bonding head holds a first bonding object and the stage has a second bonding object mounted thereon and before the first bonding object held by the bonding head comes in contact with the second bonding object mounted on the stage. The controller determines the amount of displacement (descending movement) of the bonding head based on the image captured by the camera and causes the bonding head to descend.

According to the aspect described above, the amount of the displacement of the bonding head and the like for the bonding can be set.

### BRIEF DESCRIPTION OF THE DRAWINGS

FIGS. 1A to 1C are diagrams each showing an apparatus for manufacturing a semiconductor device according to a first embodiment of the present invention.

FIG. 2 is a diagram showing the image captured by the camera 20.

FIG. 3 shows the temperature of the heater 14 and the position of the bonding head 12 with respect to elapsed time.

FIG. 4 is a diagram showing the comparative example.

FIGS. 5A and 5B are diagrams each showing a configuration of an apparatus according to a second embodiment of the present invention.

FIGS. 6A to 6C are diagrams each showing a configuration of an apparatus for manufacturing a semiconductor device according to a second embodiment of the present invention.

FIGS. 7A and 7B are diagrams showing an example of the configuration of the apparatus using the method for transferring the semiconductor chip according to the fourth embodiment of the present invention.

FIGS. 8A and 8B are diagrams each showing a modified example of fourth embodiment.

FIGS. 9A to 9C are diagrams showing an example of the configuration of the apparatus using the method for transferring the semiconductor chip according to the fourth embodiment of the present invention.

FIGS. 10A and 10B are diagrams each showing a modified example of fifth embodiment.

### BEST MODE OF CARRYING OUT THE INVENTION

In the following description of embodiments of the present invention, parts to be bonded, such as a semiconductor chip, a substrate and the like, are called “bonding objects”. For example, the semiconductor chip having a bump is regarded as a unit having the semiconductor chip and the bump and considered as one bonding object. The substrate having a bump is also considered in the same way.

Parts for bonding a bonding object to another bonding object are collectively called a “bonding member”. When the semiconductor chip and the substrate have respective bumps for the bonding, the “bonding member” means the bumps. When the semiconductor chip and the substrate have respective lands for the bonding, the “bonding member” means the lands.

### FIRST EMBODIMENT

### [Configuration of Apparatus According to First Embodiment]

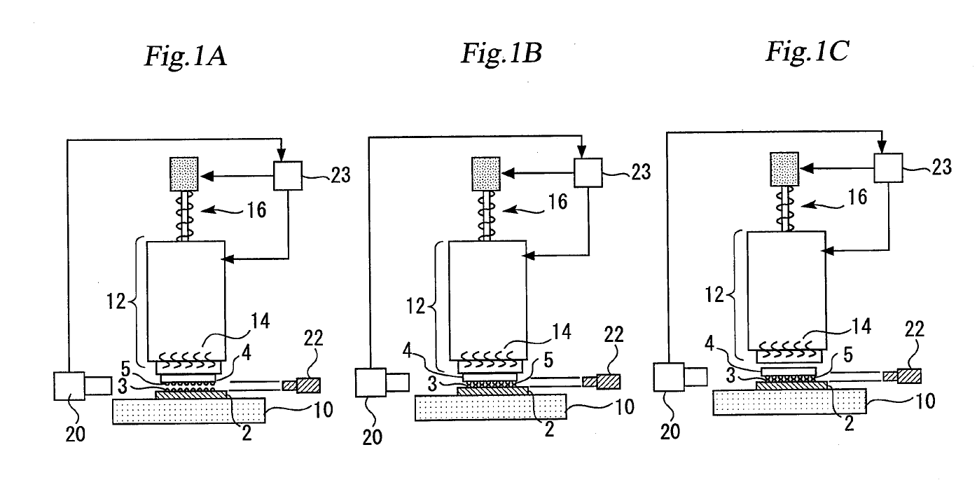

FIGS. 1A to 1C are diagrams each showing an apparatus for manufacturing a semiconductor device according to a first embodiment of the present invention. The apparatus has a stage 10 and a bonding head 12. The apparatus has a function for bonding a semiconductor chip to a substrate by means of the stage 10 and the bonding head 12. The apparatus is used to manufacture a semiconductor device having a package structure of ball grid array (BGA) type or of land grid array (LGA) type. Specifically, the apparatus is used in a flip chip bonding process of bonding a wiring substrate to a semiconductor chip. The wiring substrate is made of resin or the like and has an external electrode and a wiring connected to the external electrode. The semiconductor chip has a substrate made of silicon or the like and an integrated circuit formed on the substrate. The apparatus can be also used in a process of bonding a semiconductor chip to another semiconductor chip (an IC chip having an integrated circuit including a transistor provided on a substrate made of silicon or the like, or a chip only having a wiring formed on a substrate made of silicon or the like) to form a chip-on-chip structure.

A substrate 2 is mounted on the stage 10 and located under the bonding head 12. The substrate 2 has a plurality of bumps 3 on an upper surface (facing the upper side of the drawing sheet) thereof. The bonding head 12 is capable of holding the semiconductor chip 4 as shown in FIGS. 1A to 1C. The semiconductor chip 4 has a plurality of bumps 5 on a lower surface thereof. In the present embodiment, the bumps 3 and 5 are made of solder.

The bonding head 12 has a mechanism capable of vacuum-sucking a semiconductor chip. The mechanism is located at a position at which the bonding head 12 is in contact with the semiconductor chip 4. The bonding head 12 has a heater 14 therein. The heater 14 is capable of heating a lower end portion (located on the side of the substrate 2) of the bonding head 12 to a temperature equal to or more than the melting point (e.g., 260° C.) of the solder.

The semiconductor chip 4 held by the bonding head 12 can be heated by increasing the temperature of the heater 14. In the apparatus having the configuration described above, heat is transferred from the heater 14 through the semiconductor chip 4 to the bumps 5. Therefore, the bumps 5 can be gradually heated and melted.

The bonding head 12 is connected with a head position control mechanism 16. The head position control mechanism 16 is capable of causing the bonding head 12 to move in a vertical direction extending between the upper and lower sides of the drawing sheet.

The apparatus according to the first embodiment has a controller 23. The controller 23 is connected with the bonding head 12, the head position control mechanism 16 and the heater 14. The controller 23 provides a control signal(s) to control an operation (movement in a three-dimensional direction, vacuum sucking, and the like) of the bonding head 12 and the heating temperature of the heater 14.

The apparatus according to the first embodiment has a camera 20. The camera 20 is capable of capturing an image of a situation in which the semiconductor chip 4 comes close to the substrate 2. Specifically, the camera 20 is located on lateral sides of the semiconductor chip 4 and of the substrate 2 to observe the distance of a gap between the semiconductor chip 4 and the substrate 2. A light emitting diode (LED) lamp 22 is provided on opposite lateral sides (to the abovementioned lateral sides) of the semiconductor chip 4 and the substrate 2. The LED lamp 22 emits light to make an image captured by the camera 20 clear.

The camera 20 is connected with the controller 23. The controller 23 has a program prestored therein. The program analyzes data on an image captured by the camera 20. The program allows the actual size of a structure captured by the camera 20 to be read. As a technique for measuring an actual dimension based on image data has been already known in the conventional image analysis technology field, a detail description is not provided.

The controller 23 has stored therein a routine for calculating the amount of displacement (descending movement) of the bonding head 12 based on the image captured by the camera 20 as described later in the description of operation of apparatus. The amount the descending movement is used when the bonding head 12 actually descends. The controller 23 controls an operation of the bonding head 12 in a bonding process based on the amount of the descending movement calculated by the routine.

### [Operations of Apparatus and Manufacturing Method According to First Embodiment]

A description will be made of operations of the apparatus according to the first embodiment and a manufacturing method according to the first embodiment with reference to FIGS. 1A to 1C. FIGS. 1A to 1C show the process of bonding the semiconductor chip 4 held by the bonding head 12 to the substrate 2 mounted on the stage 10.

In the present embodiment, the temperature of the heater 14 is maintained at approximately the melting point (i.e., the melting point (260° C. or more) of solder used in the present embodiment) of a material of the bumps by the controller 23 during a process of manufacturing a semiconductor device. Specifically, the temperature of the heater 14 is maintained at 280° C. during the manufacturing process in the present embodiment. The following description is made on the assumption that the temperature of the heater 14 is maintained at 280° C. during the manufacturing process.

### (Mounting Process, Reception Process, and Melting Process)

In the present embodiment, the substrate 2 is first mounted on the stage 10. The semiconductor chip 4 is sucked by the bonding head 12 at a location (in the manufacturing apparatus) other than the location at which the substrate 2 is mounted on the stage 10. The semiconductor chip 4 is received and held by the bonding head 12. The bonding head 12 moves toward the stage 10 and is positioned above the stage 10 such that the semiconductor chip 4 and the substrate 2 face each other. After that, the bonding head 12 descends and comes close to the stage 10. The movement of the bonding head 12 temporarily stops at a position preset in the manufacturing apparatus before the solder bumps of the semiconductor chip 4 and the solder bumps of the substrate 2 come in contact with each other. FIG. 1A shows this state. As described above, the temperature of the heater 14 is maintained at the high level. The bumps 5 are melted shortly after the semiconductor chip 4 is sucked and held by the bonding head 12. In the present embodiment, therefore, the bumps 5 are already in a molten state at the time shown in FIG. 1A. On the other hand, the bumps 3 of the substrate 2 are in a solid state at the time shown in FIG. 1A.

### (Measurement Process)

In the present embodiment, the amount of the displacement (movement) of the bonding head 12 for the bonding is accurately set by a method described below. Under the condition that the bonding head 12 holds the bonding object (the semiconductor chip and the bumps) and the stage 10 has the bonding object (the substrate and the bumps) mounted thereon, and before the bonding objects come in contact with each other (hereinafter, the state before the bonding objects come in contact with each other is also called a “pre-bonding state”. FIG. 1A shows the pre-bonding state), a measurement is performed to determine the amount of displacement (descending movement) of the bonding head 12 relative to the bonding object (the substrate and the bumps) from the position of the bonding head 12 in the pre-bonding state.

In the present embodiment, the camera 20 captures an image of the gap between the semiconductor chip 4 and the substrate 2 under the condition that the movement of the bonding head 12 is temporarily stopped as shown in FIG. 1A.

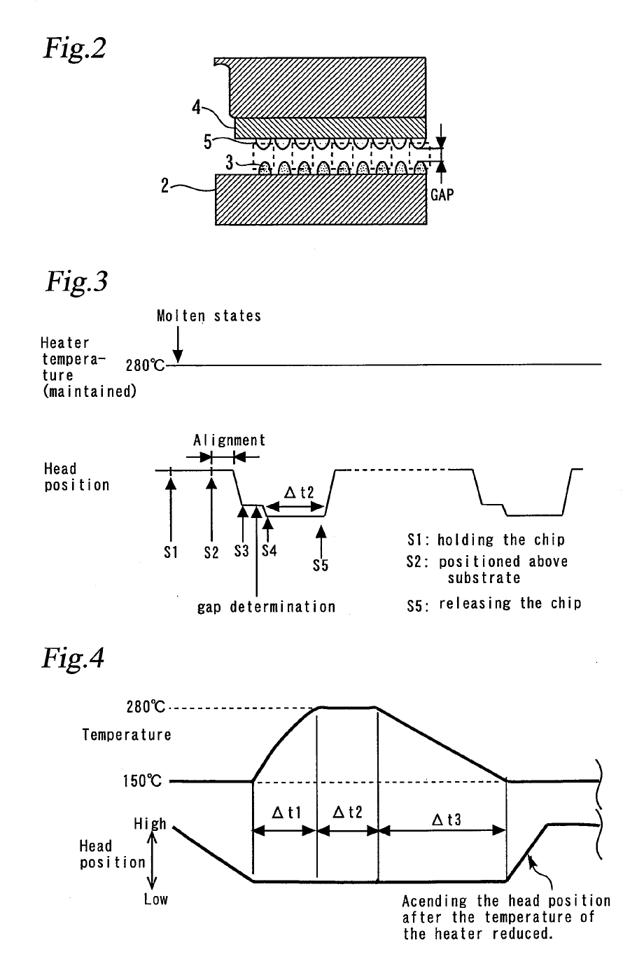

FIG. 2 is a diagram showing the image captured by the camera 20. The controller 23 acquires data on the image captured by the camera 20 and uses an image analysis technique to calculate the distance of the gap between the bonding objects. Specifically, the controller 23 calculates the distance (that is also called a GAP distance) between the bumps 3 and 5 as shown in FIG. 2. In the present embodiment, the controller 23 calculates the GAP distances between pairs (surrounded by squares indicated by broken lines) of the bumps 3 and 5 as shown in FIG. 2. After that, the controller 23 calculates the average of the calculated GAP distances.

### (Contact Process)

The controller 23 determines the amount of a descending movement of the bonding head 12 that will descend from the state shown in FIG. 2 based on the average of the calculated GAP distances. Specifically, the controller 23 determines the same distance as the average of the GAP distances or a distance obtained by adding a correction value to the average as the amount of the descending movement of the bonding head 12.

Then, the head position control mechanism 16 lowers, based on the control signal transmitted from the controller 23, the bonding head 12 (as shown in FIG. 1B) by the determined amount of the descending movement from the pre-bonding state shown in FIG. 1A. Due to the descending movement of the bonding head 12, the bumps 5 that are in a molten state come in contact with the bumps 3. The bumps 3 are then melted by the heat transferred from the bumps 5 to the bumps 3 due to the contact of the bumps 5 with the bumps 3. In the present embodiment, the temperature of the heater 14 is maintained constant in the states shown in FIGS. 1A and 1B.

According to the present embodiment, since the amount of the descending movement of the bonding head 12 is appropriately calculated, the bonding head 12 can descend to an appropriate position (at which the bumps 3 and 5 are not too close to each other and not too far from each other) even when the bumps 5 are in a molten state. As a result, excellent bonding can be stably performed in each bonding process.

### (Head Separation Process)

Subsequently, the controller 23 causes the bonding head 12 to stop vacuum-sucking the semiconductor chip 4 such that the semiconductor chip 4 is separated from the bonding head 12 as shown in FIG. 1C. In addition, the controller 23 controls the head position control mechanism 16 to cause the bonding head 12 to ascend. In the present embodiment, the temperature of the heater 14 is maintained at the high temperature when the bonding head 12 ascends. Thus, the heat is transferred from the bonding head 12 to the semiconductor chip 4 until the semiconductor chip 4 is separated from the bonding head 12. At the moment when the semiconductor chip 4 is separated from the bonding head 12, the transfer of the heat to the semiconductor chip 4 is stopped, and the temperature of the semiconductor chip 4 and the temperatures of the bumps 5 start decreasing. Then, the temperatures of the bumps 5 become sufficiently lower than the melting point of the solder. The bumps 5 become solid. As a result, the semiconductor chip 4 and the substrate 2 are bonded to each other via the bumps 3 and 5. In this way, the bonding is completed.

FIG. 3 is a diagram showing the temperature of the heater 14, changes in the position of the bonding head 12, and a timing of capturing an image by the camera 20. FIG. 3 shows the temperature of the heater 14 and the position of the bonding head 12 with respect to elapsed time. The direction from the left side of the drawing sheet to the right side of the drawing sheet corresponds to the elapsed time (time axis).

In the first embodiment, the temperature of the heater 14 is maintained at 280° C. during the manufacturing process as described above. After the bonding head 12 receives the semiconductor chip 4, the bonding head 12 holds the semiconductor chip 4 having the bumps 5 that are in the molten state in step S1 (shown in FIG. 3). Then, the bonding head 12 moves in a horizontal direction (perpendicular to the abovementioned vertical direction) while the vertical position of the bonding head 12 is constant. When the bonding head 12 is positioned above the stage 10 such that the semiconductor chip 4 faces (is positioned above) the substrate 2 in step S2, the horizontal position of the bonding head 12 is determined (the bonding head 12 is aligned with the stage 10).

After that, the bonding head 12 descends and stops in step S3 before the bumps 3 and 5 come in contact with each other. The camera 20 captures an image of the gap between the semiconductor chip 4 and the substrate 2 under the condition that the bonding head 12 is located at the stop position. The controller 23 measures the GAP distances based on the captured image and calculates the average of the GAP distances. After that, the bonding head 12 further descends based on the average of the GAP distances such that the bumps 3 and 5 come in contact with each other in step S4. Subsequently, the bonding head 12 releases the semiconductor chip 4 and starts ascending in step S5 while the temperature of the heater is maintained constant. The bonding head 12 then starts moving in the horizontal direction to receive another semiconductor chip. The apparatus repeatedly performs the operations in steps S1 to S5 on a plurality of semiconductor chips.

It is not necessary that the stage 4 include a heater. However, the stage 4 may include a heater that heats the substrate 2 to a low temperature range (e.g., about 100° C.) in which a material of the substrate 2 is resistant to heat generated by the heater provided in the stage 4.

### [Description of Effect of First Embodiment Using Comparative Example]

An Effect of the first embodiment will be described using a comparative example.

### COMPARATIVE EXAMPLE

FIG. 4 is a diagram showing the comparative example, in which the temperature of the heater 14 increases and decreases for each bonding, to explain the effect of the first embodiment. FIG. 4 shows the temperature of the heater 14 and the vertical position of the bonding head 12 with respect to elapsed time. The direction from the left side of the drawing sheet to the right side of the drawing sheet corresponds to the elapsed time (time axis). FIG. 4 shows changes in the vertical position of the bonding head 12 from the state where the position of the bonding head 12 already holding the semiconductor chip 4.

In the comparative example, the temperature of the heater 14 is set to 150° C. before the bonding head 12 descends. Therefore, the bumps 5 are in a solid state even when the bonding head 12 holds the semiconductor chip 4.

After that, the bonding head 12 descends to a predetermined position and stops, and the temperature of the heater 14 then increases, in the comparative example. As described above, the bonding head 12 stops at the position at which the bumps 5 and 3 are bonded to each other. In the comparative example, since the bonding head 12 descends under the condition that the bumps 5 are in the solid state, the bonding head 12 stops at the position at which the bumps 5 and 3 are in contact with each other.

After the heating starts, the temperature of the heater 14 increases to 280° C. In FIG. 4, the time required for increasing the temperature of the heater to 280° C. is indicated by Δt1. After that, a time Δt2 elapses, and the temperature of the heater 14 is then reduced to 150° C. in the comparative example. Due to the reduction in the temperature of the heater 14, the bumps 5 become solid, and the semiconductor chip 4 is bonded to the substrate 2 via the bumps 3 and 5. In FIG. 4, the time required for reducing the temperature of the heater 14 to 150° C. is indicated by Δt3.

After the time Δt3 elapses, the bonding head 12 releases the semiconductor chip 4 and ascends. The bonding head 12 then receives another semiconductor chip 4. Then, the same operations as those shown in FIG. 4 are performed again. In the comparative example, the bonding head 12 descends such that the bumps 3 and 5 come in contact with each other; the times Δt1, Δt2 and Δt3 then elapse; and the bonding head 12 then ascends. In this way, one bonding process is completed.

### (Effect of First Embodiment)

Comparing the first embodiment with the comparative example, the temperature of the heater 14 is maintained at 280° C. as shown in FIG. 3 in the first embodiment, while the temperature of the heater 14 is changed in the comparative example.

As a result, the time Δt1 is eliminated in the first embodiment, compared with the comparative example. The difference between the first embodiment and the comparative example is that the bumps 5 are in the molten state under the condition that the bonding head 12 holds the semiconductor chip 4 before the bonding head 12 descends in the first embodiment. The melted bumps 5 come in contact with the bumps 3 in the first embodiment. Therefore, the time Δt1 required for melting the bumps 5 is not necessary, unlike the comparative example.

In addition, the time Δt3 required in comparative example is not required in the first embodiment. That is, the bonding head 12 releases the semiconductor chip 4 and starts ascending under the condition that the temperature of the heater 14 is maintained at 280° C. in the first embodiment, as described in the item “Head separation process”. Therefore, the time required for reducing the temperature of the heater 14 is not required in the first embodiment, unlike the comparative example.

Consequently, the bonding process in the first embodiment can be performed without the time Δt3 required for cooling the bumps 5 to cause the bumps 5 to become solid, compared with the process in which the bonding head 12 ascends after the reduction in the temperature of the bonding head 12. As a result, a time required for manufacturing a semiconductor device can be reduced. In the comparative example, the rate of the increase in the temperature of the heater can be easily increased by increasing power of the heater. The temperature of the heater is reduced by turning off the heater to cause the heater to be naturally cooled. Thus, the time Δt3 is longer than the time Δt1 in general. Typically, the time Δt1 is 1 second to 2 seconds, while the time Δt3 is 4 seconds to 5 seconds. The time Δt3 is therefore longer by twice or more than the time Δt1. It is more effective for the time reduction to eliminate the time Δt3 required for cooling the bumps 5 than elimination of the time Δt1 required for melting the bumps 5, as in the first embodiment.

According to the first embodiment, the bumps 5 can be naturally solid under the condition that an external force is not applied to the bumps from the bonding head 12 since the bonding head 12 releases the semiconductor chip 4 under the condition that the bumps 5 are in the molten state. In this case, there is an advantage that an internal stress remaining in the bumps 5 can be reduced. In the comparative example in which the temperature of the heater 14 is reduced to cool the bumps 5 to cause the bumps 5 to become solid, a force is applied to the bumps 5 from the side of the bonding head 12 in the process of cooling the bumps 5 to cause the bumps 5 to become solid. Due to the force applied to the bumps 5, an unnecessary stress remains in the bumps 5 after the bumps become solid.

The internal stress that remains the bumps 5 when the bumps 5 become solid can be suppressed in the first embodiment, compared with the comparative example. At least the stress (caused by the bonding head 12) remaining in the bumps 5 can be eliminated in the first embodiment. As a result, high-quality bump bonding can be performed from the perspective of the suppression of the remaining stress. In the first embodiment, since the bonding head 12 releases the semiconductor chip 4 and ascends under the condition that the temperature of the heater 14 is maintained at the high level, high-quality bonding of the bumps 3 and 5 can be performed.

As described above, the semiconductor chip 4 is placed above the substrate 2 via the bumps 3 and 5 under the condition that the temperature of the heater 14 is maintained at the level higher than the melting point of the bump material in the first embodiment. This process is repeated in the first embodiment. Since the temperature of the heater 14 is maintained at the level higher than the melting point of the bump material, the bonding head 12 can be operated at the maximum speed without consideration of the status of an operation for controlling the heater.

As described above, the amount of the descending movement of the bonding head 12 is appropriately set through the measurement using the camera 20 or the like in the first embodiment, unlike the method using the load cell, which is disclosed in JP-A-2006-73873.

As described above, the measurement is performed based on the image captured by the camera 20 in the pre-bonding state, and the amount of the descending movement of the bonding head 12 is set based on the measured value, in the first embodiment. Then, the bonding head 12 descends by the set amount of the descending movement from the pre-bonding state.

The bonding head 12 can therefore descend to an appropriate position at which the bumps 3 and 5 are not too close to each other and not too far from each other even when the bumps 5 are in a molten state. As a result, excellent bonding can be stably performed in each bonding process.

In the method for the measurement through the image analysis using the camera in the first embodiment, non-contact measurement of bonding objects can be performed. That is, an optical measurement technique for detecting light (more specifically, contrast of two types of light, which are light that is formed by an optical source such as the LED lamp 22 or the like and comes from the gap between the two bonding objects, and light that is formed by the optical source and comes from the two bonding objects) from the bonding objects is used to perform the non-contact measurement on the semiconductor chip and the bonding object. Therefore, the distance of the gap can be reliably measured even when the bumps are in the molten state.

In addition, since the measurement method uses the image analysis, a time (shown in FIG. 3) required for detecting the GAP distances is reduced approximately one tenth of the time Δt1 in the comparative example shown in FIG. 4. For example, the detection of the GAP distances takes 0.1 seconds. In the first embodiment, therefore, the time required for the bonding process can be reduced even when the time Δt1 is eliminated and the time required for the detection of the GAP distances is added. Furthermore, in this measurement method, the distances between pairs of members can be collectively acquired. This is significantly effective from the perspective of the acquisition of the average of the GAP distances between the pairs of members.

In the contact detection technique using the load cell as described in JP-A-2006-73873, since the time point at which the descending movement of the bonding head is stopped cannot be estimated, it is necessary that the speed of the descending movement of the bonding head be suppressed (decreased) to a certain extent. On the other hand, in the first embodiment, after the alignment is performed, the bonding head 12 descends by a predetermined amount of the descending movement and temporarily stops before the apparatus is operated. Then, the GAP distances are measured. After a time for the measurement of the GAP distances elapses, the bonding head 12 descends by the amount (of the descending movement) determined based on the measurement result. That is, since the bonding head 12 is controlled after the amount of the descending movement of the bonding head 12 is determined, it is not necessary that the speed of the movement of the bonding head 12 be limited. Therefore, the speed of the descending movement of the bonding head 12 in the first embodiment can be higher than the speed of the descending movement of the bonding head in the contact detection technique using the load cell. This position control technique according to the present embodiment is excellent since the position control technique contributes to the further reduction in the time required for the bonding process.

As described above, both the reduction in the time required for the bonding process and appropriate adjustment of the amount of the descending movement of the bonding head 12 can be realized in the first embodiment. Therefore, a high-speed, stable bonding process can be performed while uniform bump bonding is achieved in each process.

### MODIFIED EXAMPLES OF FIRST EMBODIMENT

### First Modified Example

In the first embodiment, only the bonding head 12 incorporates the heater 14. The present invention, however, is not limited to this configuration of the apparatus. In a first modified example, the stage 10 may incorporate a heater while the bonding head 12 does not have a heater. Alternatively, both the bonding head 12 and the stage 10 may incorporate respective heaters. In this case, the semiconductor chip having the bumps is mounted on the stage 10, and the temperature of the heater incorporated in the stage 10 may be adjusted to increase to a level more than the melting point of the bump material in the same way as the adjustment of the temperature of the heater 14.

In addition, the bonding object placed on the side of the stage 10 may not have a bump while the bonding object placed on the side of the bonding head 12 have a bump, unlike the first embodiment. In this case, the measurement to determine the amount of the descending movement of the bonding head 12 uses the same technique as that in the first embodiment. For example, the following distance is measured: the distance between the tip of the bump of the semiconductor chip and a land (or a portion of an upper surface of the substrate, which is in the vicinity of the land) to which the bump of the substrate is bonded.

### Second Modified Example

In the first embodiment, the temperature of the heater 14 is maintained at the level higher than the melting point of the bump material before and after the bonding, and the times Δt1 and Δt3 in the comparative example are eliminated. Only the idea (in other words, only a technique related to the head separation process in the first embodiment) of eliminating the time Δt3 can be independently used.

Specifically, the temperature of the heater 14 is first set to be low in the same manner as in the comparative example, and the bonding head 12 then descends. After the bumps 3 and 5 come in contact with each other, the temperature of the heater 14 increases. In a second modified example, the amount of the descending movement of the bonding head 12 may be determined by measuring the appearances of the bonding objects by means of an optical unit such as the camera 20 in the same manner as in the first embodiment. Alternatively, a load cell may be provided for the bonding head 12 to detect the contact of the bumps and to thereby determine the amount of the descending movement of the bonding head 12. After the determination of the amount of the descending movement, and a time corresponding to the time Δt2 elapses, the bonding head 12 ascends under the condition that the temperature of the heater 14 is maintained at a high level. This makes it possible to eliminate the time Δt3 and reduce the stress remaining in the bumps.

When only the idea of eliminating the time Δt3 is used, the measurement and the calculation of the amount of the displacement (which are performed in the pre-bonding state in the first embodiment) are not required. This results from the fact that the elimination of the time Δt3 and the suppression of the stress remaining in the bumps can be realized by separating the semiconductor chip 4 from the bonding head 12 under the condition that the temperature of the heater is maintained at a high level regardless of operations performed in the manufacturing process before the head separation process.

### Third Modified Example

In the first embodiment, the temperature of the heater 14 is maintained at a level (specifically, 280° C. or more in the first embodiment) higher than the melting point of the bump material during the bonding process, as shown in FIG. 3. The present invention, however, is not limited to the temperature range. This results from the fact that it is only necessary to cause the bumps 5 in the molten state to come in contact with the bump 3 from the perspective of elimination of the time Δt1. The temperature of the heater 14 may be low instantaneously or for a certain time, except when the bumps 3 and 5 are in contact with each other as shown in FIG. 1B.

For example, even when the temperature of the heater 14 is low at the moment when the binding head 12 receives the semiconductor chip 4, the temperature of the heater 14 may be set to a high level during transfer of the semiconductor chip 4 and before the pre-bonding state, and the bumps may become in the molten state before the bumps 3 and 5 come in contact with each other.

### Fourth Modified Example

In the first embodiment, the solder having a melting point of 260° C. is used to form the bumps 3 and 5. The material of the bumps is not limited to the solder. As the material of the bumps, lead-free solder not containing lead or lead-free solder containing a small amount (less than 0.1 wt %) of lead (having a small environmental load) may be used. As the lead-free solder, a material made of tin containing copper of 1% to 4% may be used. In addition, as the lead-free solder, Sn—Bi family alloys, Sn—Ag family alloys, pure Sn and the like may be used.

The temperature of the heater 14 during the manufacturing process may be changed based on the melting point of the bump material. An output of the heater 14 may be sufficiently large such that the temperatures (increased by the heat transferred through the bonding head 12 and the semiconductor 4) of the bumps 5 are higher than the melting point of the bump material. As an example, when a solder material containing Sn, Ag of 1% and Cu of 0.5% is used, the melting point of the solder material is 210° C.

### Fifth Modified Example

In the first embodiment, the distance (GAP distance shown in FIG. 2) between the tip (lower tip of each of the bumps 5 of the semiconductor chip 4) of each bonding member of one of the two bonding objects and the tip (upper tip of each of the bumps 3 of the substrate 2) of each bonding member of the other of the two bonding objects is measured. The position of the bonding head 12 is controlled based on the average of the measured GAP distances.

However, the values measured for the control of the position of the bonding head 12 do not mean only the GAP distances. The bonding object includes bonding members (the bumps) and a non-bonding member (the surface of the semiconductor chip or the surface of the substrate). The surface of the bonding object is irregular. Thus, the distance of the gap between the two bonding objects is not constant when the bonding objects are viewed from the horizontal direction.

The minimum distance between the two bonding objects is a gap (distance between the bumps facing each other, or GAP distance) between the tip of the bonding member of one of the two bonding objects and the tip of the bonding member of the other of the two bonding members when the two bonding objects are positioned such that the bonding members face each other. The maximum distance between the two bonding objects is a gap (distance between non-bump members, e.g., distance between a lower surface of the semiconductor chip and an upper surface of the substrate) between the non-bonding members. The distance of the gap between the bonding objects includes the two types of values.

To reflect a variation of the distances, the distance between the non-bonding members may be measured and used. Specifically, as a modified example of the first embodiment, the distance (hereinafter also called a “chip-substrate gap distance”) between the lower surface of the semiconductor chip 4 and the upper surface of the substrate 2 may be measured instead of the GAP distances.

In this case, a difference between the measured chip-substrate gap distance and a predetermined reference distance is calculated, and the bonding head 12 descends by the difference such that the bonding is performed. This operation makes it possible to maintain the gap between the semiconductor chip and the substrate to be constant in each bonding process. As a result, a plurality of semiconductor devices in which the chip-substrate gap distances are the same as each other can be manufactured. When the distance between the lower surface of the semiconductor chip and the upper surface of the substrate is important to meet specifications of the semiconductor device to be manufactured, the abovementioned operation can be adopted. In addition, distances between the tips of the bumps of one of the two bonding objects and the surface of the non-bump member of the other of the bonding objects may be measured, and the position of the bonding head 12 may be controlled based on the measured distances.

### Sixth Modified Example

In the first embodiment, the bonding head 12 descends in order that the semiconductor chip 4 and the substrate 2 are bonded to each other via the bumps 3 and 5. However, the stage 10 may ascend in order that the semiconductor chip 4 and the substrate 2 are bonded to each other via the bumps 3 and 5. In this case, the amount of the descending movement determined by the controller 23 is used as the amount of displacement of the stage 10 from the pre-bonding state, and the stage 10 ascends by the amount of the displacement toward the bonding head 12 from the pre-bonding state. In addition, both the bonding head 12 and the stage 10 may be movable. In this case, the bonding head 12 and the stage 10 come close to each other based on the amount of the displacement.

### SECOND EMBODIMENT

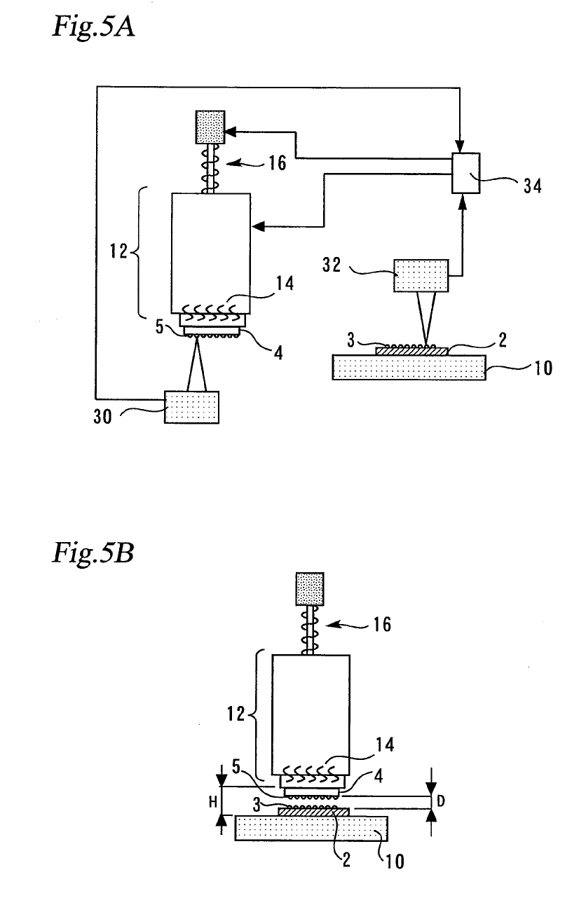

A second embodiment of the present embodiment will be described with reference to FIGS. 5A and 5B. In the second embodiment, a measurement is performed in the pre-bonding state to determine the amount of a descending movement of the bonding head 12, and the position of the bonding head 12 is accurately controlled, in the manner common to the first embodiment.

In the second embodiment, the dimension of each bonding object is individually measured unlike the first embodiment, and the amount of the descending movement is calculated based on the measurement result.

### [Configuration of Apparatus According to Second Embodiment]

As shown in FIGS. 5A and 5B, an apparatus according to the second embodiment has a laser displacement meter 30 and a laser displacement meter 32. The laser displacement meter 30 is located under and separated from the bonding head 12 to measure the thickness of the semiconductor chip 4. The surface of the laser displacement meter 30 faces the lower surface of the semiconductor chip 4. The laser displacement meter 32 is located above and separated from the stage 10 to measure the thickness of the substrate 2. The surface of the laser displacement meter 32 faces the upper surface of the stage 10. As the principle and configuration of each of the laser displacement meters are already known, detail description thereof is not provided.

The apparatus according to the second embodiment has a controller 34. The controller 34 is connected with the bonding head 12, the head position control mechanism 16 and the heater 14 to control them in the same manner as the controller 23 used in the first embodiment. The controller 34 is also connected with the laser displacement meters 30 and 32, and capable of acquiring data on results of measurements performed by the laser displacement meters 30 and 32.

The controller 34 is configured to detect the position of the bonding head 12 relative to the stage 10. For example, when the head position control mechanism 16 is a mechanism for numerical control, the controller 34 can easily detect the position of the bonding head 12 relative to the stage 10 by referencing a control value of the head position control mechanism 16. Alternatively, an additional device for measuring the position of the bonding head 12 relative to the stage 10 may be provided and connected with the controller 34.

### [Operations of Apparatus and Manufacturing Method According to Second Embodiment]

Next, a description will be made of operations of the apparatus according to the second embodiment and a manufacturing method according to the second embodiment with reference to FIGS. 5A and 5B. The output temperature of the heater 14 is maintained at 280° C. in the same manner as in the first embodiment. As adjustment of the temperature of the heater 14 is performed in the same manner as in the first embodiment, description thereof is omitted.

In the second embodiment, the laser displacement meter 30 is used to measure the thickness of the semiconductor chip 4. Specifically, the laser displacement meter 30 is arranged such that a distance (measured in the vertical direction) between the surface of the laser displacement meter 30 and the surface (with which the semiconductor chip comes in contact) of the bonding head 12 is constant. The surface (with which the semiconductor chip is in contact) of the bonding head 12 is hereinafter called a “contact surface”. The laser displacement meter 30 emits a laser beam onto the contact surface of the bonding head 12 under the condition that the bonding head 12 does not hold the semiconductor chip 4 and others on the contact surface. The laser displacement meter 30 detects light reflected from the contact surface to measure the distance (measured in the vertical direction) between the surface of the laser displacement meter 30 and the contact surface of the bonding head 12 in advance (the result of this measurement is represented by H1).

After the bonding head 12 holds the semiconductor chip 4 during a bonding process, the laser displacement meter 30 emits a laser beam onto a portion (on which the bumps 5 are not provided) of the lower surface of the semiconductor chip 4 under the condition the bonding head 12 holds the semiconductor chip 4 as shown in FIG. 5A. The laser displacement meter 30 detects light reflected from the portion of the lower surface of the semiconductor chip 4 to measure a distance between the surface of the displacement meter 30 and the lower surface of the semiconductor chip 4 (the result of this measurement is treated by H2).

The laser displacement meter 32 is arranged such that a distance (measured in the vertical direction) between the surface of the laser displacement meter 30 and the surface (on which the substrate 2 is to be placed) of the stage 10 is constant. The surface (on which the substrate 2 is mounted) of the stage 10 is hereinafter called a “mounting surface”. The laser displacement meter 32 emits a laser beam onto the mounting surface of the stage 10 under the condition that the stage 10 does not have the substrate 4 and others on the mounting surface. The laser displacement meter 32 detects light reflected from the mounting surface of the stage 10 to measure a distance (measured in the vertical direction) between the surface of the laser displacement meter 32 and the mounting surface of the stage 10 in advance (the result of this measurement is represented by H3).

After the substrate 2 is mounted on the stage 10 during the bonding process, the laser displacement meter 32 emits a laser beam onto a portion (on which the bumps 3 are not provided) of the upper surface of the substrate 2 under the condition that the stage has the substrate 2 mounted thereon as shown in FIG. 5A. The laser displacement meter 32 detects light reflected from the portion of the upper surface of the substrate 2 to measure a distance between the surface of the laser displacement meter 32 and the upper surface of the substrate 2 (the result of this measurement is represented by H4).

The laser displacement meters 30 and 32 obtain the measurement results H2 and H4 simultaneously, respectively. The controller 34 receives the measurement results H2 and H4 from the laser displacement meter 30 and 32. The controller 23 receives the measurement results H1 and H3 before the controller 34 receives the measurement results H2 and H4. After that, the controller 34 causes the bonding head 12 to move toward the stage 10 in the horizontal direction from the position of the bonding head 12 shown in FIG. 5A in order that the semiconductor chip 4 is located above the substrate 2 as shown in FIG. 5B.

As described above, the controller 34 is capable of detecting the position of the bonding head 12 relative to the stage 10. That is, the controller 34 is capable of obtaining a distance (denoted by H in FIG. 5B) between the contact surface of the bonding head 12 and the mounting surface of the stage 10. According to the second embodiment, the thickness of the semiconductor chip 4, the thickness of the substrate 2, and the distance H are obtained at the time shown in FIG. 5B.

A value obtained by subtracting the thickness of the semiconductor chip 4 and the thickness of the substrate 2 from the distance H is equal to a distance D (shown in FIG. 5B) between the lower surface of the semiconductor chip 4 and the upper surface of the substrate 2. A value obtained by subtracting a predetermined reference distance R from the distance D is regarded as the amount of the descending movement of the bonding head 12. The reference distance R is determined in advance based on specifications of a semiconductor device to be manufactured. Specifically, the controller 34 calculates the following expression: the distance H−(the measurement result H1−the measurement result H3)−(the measurement result H2−the measurement result H4)−the reference distance R. The controller 34 determines the calculated result as the amount of the descending movement of the bonding head 12. The controller 34 controls the head position control mechanism 16 to cause the bonding head 12 to descend by the determined amount of the descending movement and to thereby bond the bumps 3 and 5 to each other. These operations make it possible to maintain the distance between the lower surface of the semiconductor chip 4 and the upper surface of the substrate 2 to be constant in each bonding process even when the dimensions of the parts vary. Therefore, a plurality of semiconductor devices can be manufactured while the chip-substrate gap distances are equal to each other.

As described above, the position of the bonding head 12 is accurately controlled in the second embodiment through a technique different from the technique used in the first embodiment. Therefore, a high-speed, stable bonding process can be performed while excellent bump bonding is achieved in each process in the second embodiment, similarly to the first embodiment.

The optical measurement technique described in the second embodiment can be used to perform non-contact measurement of semiconductor chips and of bonding objects. The distance between the bonding objects can be reliably measured even when the bumps are in the molten state.

The configurations and methods described in the modified examples of the first embodiment may be applied to the second embodiment.

### Third Embodiment

A third embodiment of the present invention provides a high-speed bonding process of bonding semiconductor chips to each other to form a semiconductor device having a chip-on-chip structure.

### [Configuration of Apparatus According to Third Embodiment]

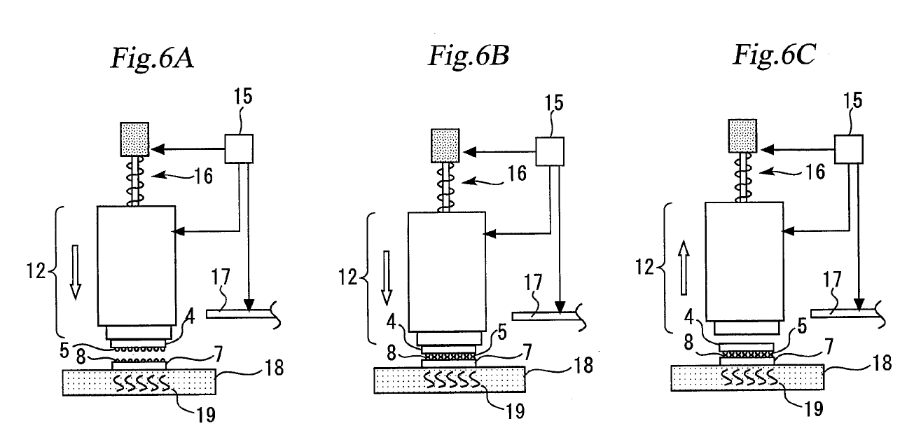

FIGS. 6A to 6C are diagram showing the configuration of an apparatus according to the third embodiment and a manufacturing method according to the third embodiment. The apparatus according to the third embodiment has a bonding head 12 and a stage 18 incorporating a heater 19. It should be noted that the bonding head 12 does not have the heater 14 in the third embodiment.

As shown in FIGS. 6A to 6C, a semiconductor chip 7 is mounted on the stage 18 instead of the substrate 2 in the third embodiment. As the semiconductor chip 7, the following may be used: an IC chip having an integrated circuit (including a transistor) formed on a substrate made of silicon or the like; or a chip having only a wiring formed on a substrate made of silicon or the like. The semiconductor chip 7 has a plurality of bumps 8 on an upper surface (facing the upper side of the drawing sheet) thereof. In this way, the manufacturing apparatus according to the third embodiment bonds the semiconductor chip 4 to the semiconductor chip 7 to form a chip-on-chip structure.

The heater 19 is capable of increasing the temperature of an upper surface of the stage 18 to a temperature equal to or more than the melting point (e.g., 260° C.) of the solder. The semiconductor chip 7 mounted on the stage 18 can be heated by increasing the temperature of the heater 19. The heat generated by the heater 19 is transferred to the bumps 8 through the semiconductor chip 7 to gradually heat and melt the bumps 8.

As shown in FIGS. 6A to 6C, the apparatus according to the third embodiment has an arm 17. The arm 17 is capable of carrying the semiconductor chips 4 and 7 bonded to each other from a place located on the stage 18 to another place. The apparatus according to the third embodiment also has a controller 15. The controller 15 is capable of controlling an operation of the bonding head 12, an operation of the arm 17, and the temperature of the heater 19. It should be noted that the apparatus according to the third embodiment does not include a measurement device such as the camera 20 used in the first embodiment as shown in FIGS. 6A to 6C.

### [Operations of Apparatus and Manufacturing Method According to Third Embodiment]

A description will be made of operations of the apparatus according to the third embodiment and a manufacturing method according to the third embodiment with reference to FIGS. 6A to 6C. FIGS. 6A to 6C show a process of bonding the semiconductor chip 4 held by the bonding head 12 to the semiconductor chip 7 mounted on the stage 18.

In the present embodiment, the temperature of the heater 19 is maintained at about the melting point (i.e., 260° C. or more in the present embodiment) of the solder during a manufacturing process, in the same manner as the heater 14 used in the first embodiment. Specifically, the temperature of the heater 19 is maintained at 280° C. during the manufacturing process in the present embodiment. The following description is made on the assumption that the temperature of the heater 19 is maintained at 280° C. during the manufacturing process.

### (Mounting Process, Reception Process, and Melting Process)

In the third embodiment, the semiconductor chip 7 is first mounted on the stage 18 as shown in FIG. 6A, and the semiconductor chip 4 is held by the bonding head 12. Since the temperature of the heater 19 is maintained at the high level as described above, the bumps 8 are melted shortly after the semiconductor chip 7 is mounted on the stage 18. In the third embodiment, the bumps 8 are already in a molten state at the time shown in FIG. 6A, similarly to the case where the bumps 5 are already in the molten state at the time shown in FIG. 1A in the first embodiment. On the other hand, the bumps 5 are in a solid stage in the third embodiment.

### (Contact Process)

After that, the bonding head 12 descends by a predetermined distance as shown in FIG. 6B, in the same manner as in the first embodiment. Due to the descent of the bonding head 12, the bumps 5 in the solid state come in contact with the bumps 8 in the molten state. Similarly to the first embodiment, the temperature of the heater 19 is maintained constant in the states shown in FIGS. 6A and 6B.

### (Head Separation Process)

Subsequently, the bonding head 12 releases the semiconductor chip 4 and ascends as shown in FIG. 6C. The temperature of the heater 19 is maintained at the high level during the ascent of the bonding head 12. Thus, the bumps 8 remain in the molten state at the moment when the bonding head 12 and the semiconductor chip 4 are separated from each other.

After that, the arm 17 carries the bonding objects having a chip-on-chip structure including the semiconductor chips 4 and 7 and the bumps 5 and 8 from the place located on the stage 18 to another place. In this case, the transfer of the heat to the semiconductor chip 7 is stopped when the bonding objects having the chip-on-chip structure are separated from the stage 18 by the arm 17. The temperatures of the bumps 8 then start decreasing. As a result, the temperatures of the bumps 8 are sufficiently lower than the melting point of the solder, and the bumps 8 become solid. The bumps 5 and 8 are then bonded to each other. In this way, the bonding is completed.

### [Effect of Third Embodiment]

According to the third embodiment, the bonding head 12 descends in order to perform the bonding under the condition that the bumps 8 of the semiconductor chip 7 mounted on the stage 18 are in the molten state. It is, therefore, not necessary to include, in the bonding process, the time (Δt1 described in the comparative example of the first embodiment) required for increasing the temperature of the heater to heat and melt the bumps after the movement of the bonding head 12 is stopped.

According to the third embodiment, the semiconductor chip 4 is separated from the bonding head 12 under the condition that the bumps 8 are in the molten state. After that, the arm 17 causes the bonding objects bonded to each other to be separated from the stage 18. Thus, the manufacturing process can be performed for a short time without a time for reducing the temperature of the heater 19. The bonding process can therefore be performed for a short time without a time corresponding to the time Δt3 described in the comparative example of the first embodiment. In addition, the bumps become solid under the condition that an external force is not applied to the bumps 5 from the bonding head 12. In this case, there is an advantage that an internal stress remaining in the bumps can be reduced.

As described above, the process, in which the semiconductor chip 4 is placed above the semiconductor chip 7 via the bumps, is repeated under the condition that the temperature of the heater 19 is maintained at the level higher than the melting point of the bump material in the third embodiment. Since the output temperature of the heater 19 is maintained at the level higher than the melting point of the bump material, the bonding head 12 can be operated at the maximum speed without consideration of the status of an operation for controlling the heater.

### MODIFIED EXAMPLES OF THIRD EMBODIMENT

### First Modified Example

In the third embodiment, the temperature of the heater 19 is maintained at the level higher than the melting point of the bump material before and after the bonding, and the times Δt1 and Δt3 in the comparative example of the first embodiment are eliminated. However, only a time corresponding to the time Δt3 (described in the comparative example) after the bonding may be eliminated. For example, the temperature of the heater 19 increases after the descent of the bonding head 12, unlike the third embodiment. The temperature of the heater 19 is maintained at the high level during the ascent of the bonding head 12, in the same manner as in the third embodiment. After that, the temperature of the heater 19 decreases at an appropriate timing. The bonding head 12 then receives another semiconductor chip, and the same process is repeated. In this method, at least a time corresponding to the time Δt3 can be eliminated in the bonding process.

### Second Modified Example

According to the third embodiment, only a time corresponding to the time Δt1 (described in the comparative example) before the bonding may be eliminated. Specifically, the following operations may be performed: the temperature of the heater 19 is maintained at the high level before the bonding head 12 descends as shown in FIG. 6A in the same manner as in the third embodiment; the bonding head 12 descends such that the bumps 5 come in contact with the bumps 8 in the molten state; the temperature of the heater 19 then decreases; the bonding head 12 then ascends; the temperature of the heater 19 then increases at an appropriate timing; the bonding head 12 receives another semiconductor chip; and the same process is repeated. In this method, at least a time corresponding to the time Δt1 can be eliminated in the bonding process.

### Other Modified Examples

The temperature of the heater 19 may not be always maintained at a temperature higher than the melting point of the bump material in the third embodiment, in the same manner as the modified examples of the first embodiment. In addition, the material of the bumps 5 and 8 may be changed, and the temperature of the heater 19 may be changed based on the material of the bumps 5 and 8, in the same manner as in the modified examples of the first embodiment.

The apparatus according to the third embodiment may include the bonding head 12 having the heater 14, and the stage 18 having the heater 19. The heaters 14 and 19 may be controlled to radiate heat of approximately 280° C. before the bumps of one of the two bonding objects come in contact with the bumps of the other of the two bonding objects. In this case, under the condition that both the bumps of the bonding object located on the side of the bonding head 12 and the bumps of the bonding object located on the side of the stage 18 are in the molten state, the bumps of one of the two bonding objects and the bumps of the other of the two bonding objects come in contact with each other.

In addition, when the bonding head 12 ascends after the bonding, the arm 17 may move the bonding objects (having a chip-on-chip structure) bonded to each other, as described in the third embodiment. In this method, the bonding process can be performed for a shot time while adverse effects such as a change in the shape of the bump and dispersal of the bump material are prevented. It is preferable that this method be used when a semiconductor device having a chip-on-chip structure is manufactured in the same manner as in the third embodiment, from the perspective of heat resistance.

The techniques (described in the first and second embodiments) for calculating the amount of the descending movement of the bonding head 12 may be used in the third embodiment. That is, the camera 20 and the LED lamp 22 may be provided in the apparatus according to the third embodiment, in the same manner as in the first embodiment. Alternatively, the laser displacement meters may be provided in the apparatus according to the third embodiment, in the same manner as in the second embodiment. In these configurations, the two bonding objects are measured in the pre-bonding state by means of the same techniques as in the first and second embodiments. The amount of a reduction in the distance between the contact surface of the bonding head 12 and the mounting surface of the stage 10 is determined based on the result of the measurement. The bonding head 12 descends from the pre-bonding state based on the amount of the reduction in the distance (or the stage 10 ascends from the pre-bonding state based on the amount of the reduction in the distance).

The apparatus may be configured such that the bonding object located on the side of the stage 10 has a bump and the bonding object located on the side of the bonding head 12 does not have a bump.

### Fourth Embodiment

The semiconductor chip may be placed on a chip holding stage (semiconductor chip tray or the like) and stored (or stands by for the bonding process) such that the bumps of the semiconductor chip extend downward. In this case, when the bonding head 12 having a high temperature comes in contact with the semiconductor chip, the temperature of the semiconductor chip immediately increases, and the bumps of the semiconductor chip are melted.

As a result, the bumps may be broken or transformed. In addition, the melted bump material may be attached to the chip holding stage. In such a case, the reception of the semiconductor chip by the bonding head 12 is not excellent. To avoid the problems, the fourth embodiment uses the following method to transfer the semiconductor chip.

### [Configuration of Apparatus According to Fourth Embodiment]

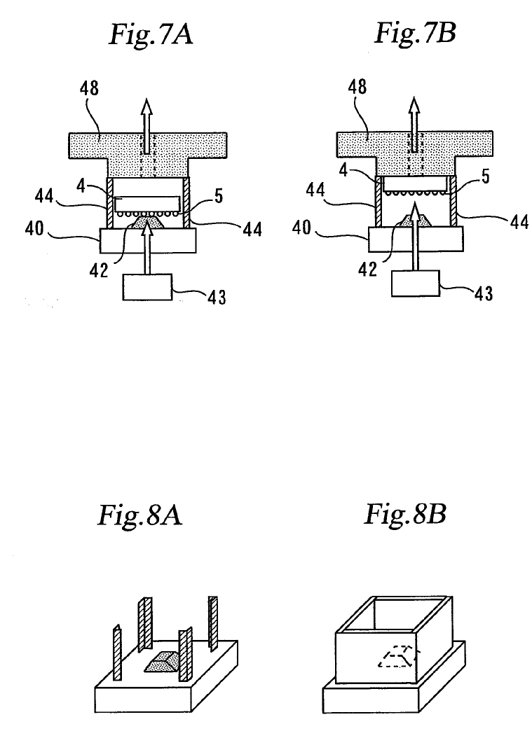

FIGS. 7A and 7B are diagrams showing an example of the configuration of the apparatus using the method for transferring the semiconductor chip according to the fourth embodiment of the present invention. FIG. 7A shows a chip holding stage 40. The chip holding stage 40 has a rubber collet 42. The semiconductor chip 4 having the bumps 5 is placed on the rubber collet 42. The bumps 5 are made of solder.

The rubber collet 42 and the chip holding stage 40 have respective through holes extending in a vertical direction extending between the upper and lower sides of the drawing sheet. The through hole of the rubber collet 42 and the through hole of the chip holding stage 40 communicate with each other. An air jet mechanism 43 is provided under the chip holding stage 40. The air jet mechanism 43 is capable of blowing air from the lower side of the drawing sheet through the through holes to a direction indicated by an arrow shown in FIGS. 7A and 7B. The semiconductor chip 4 placed on the rubber collet 42 can be lifted up toward the upper side of the drawing sheet by the blown air.

A guide 44 is provided around the rubber collet 42. The guide 44 is a plate-like member and made of rubber. The guide 44 surrounds the rubber collet 42 from four sides of the rubber collet 42. As a result, the guide 44 forms a convex portion surrounding the semiconductor chip 4. FIG. 7A shows portions of the guide 44, which are located on the left and right sides of the drawing sheet, for convenience of the explanation. FIG. 7A does not show portions of the guide 44, which are located on the front and back sides of the drawing sheet. The vertical position of an upper end portion of the guide 44 is higher than the vertical position of an upper surface of the semiconductor chip 4 above the rubber collet 42.

FIG. 7A shows a bonding head 48 that holds the semiconductor chip 4. The bonding head 48 has a heater and a vacuum sucking mechanism in the same manner as in the first to third embodiments. The vacuum sucking mechanism is controlled to cause the bonding head 48 to suck the semiconductor chip 4 toward a direction indicated by an arrow shown in each of FIGS. 7A and 7B (toward the upper side of the drawing sheet).

### [Operations of Apparatus According to Fourth Embodiment]

The bonding head 48 stops for the transfer of the semiconductor chip 4 at a position at which the bonding head 48 is separated by a predetermined distance (e.g., approximately 0.5 mm to 1 mm) from the semiconductor chip 4 as shown in FIG. 7A. The predetermined distance is set such that the bumps 5 of the semiconductor chip 4 are not melted even when the temperature of the heater provided in the bonding head 12 increases to a high level (higher than the melting point of the bump material).

The vacuum sucking mechanism and the air jet mechanism 43 are simultaneously operated under the abovementioned condition. In this case, the vacuum sucking mechanism causes the bonding head 12 to suck the semiconductor chip 4, and the air jet mechanism 43 operates to lift up the semiconductor chip 4 from the side of the rubber collet 42. The semiconductor chip 4 is transferred from the side of the rubber collet 42 to the bonding head 12, and then sucked by the bonding head 12 as shown in FIG. 7B. In this case, the guide 44 allows the semiconductor chip 4 to be transferred toward the upper side of the drawing sheet and serves to position the semiconductor chip 4 with high precision.

As described above, the operation for transferring the semiconductor chip 4 is performed under the condition that the bonding head 48 is separated by the predetermined distance from the semiconductor chip 4 in the present embodiment. Therefore, this operation prevents the melted bumps 5 from being attached to the rubber collet 42, broken and transformed. In addition, the guide 44 allows the semiconductor chip 4 to be transferred toward the upper side of the drawing sheet and serves to position the semiconductor chip 4 with high precision.

When the semiconductor chip 4 is transferred to the bonding head 48, the temperature of the semiconductor chip 4 immediately increases, and the bumps 5 of the semiconductor chip 4 are melted. After that, bonding is performed in the same manner as in the first to third embodiments. A time required to increase the temperature of the heater can be reduced in the same manner as in the first to third embodiments since the process of bonding the semiconductor chip 4 can be performed under the condition that the bumps 5 are in the molten state.

### MODIFIED EXAMPLE OF FOURTH EMBODIMENT

The guide 44 serves to increase the precision of the transfer of the semiconductor chip in the fourth embodiment. The guide 44, however, is not necessarily required. The semiconductor chip 4 may be transferred to the bonding head 12 without the guide 44.

Referring to FIG. 8A, column-shaped members having respective L-shaped cross sections may be arranged at four corners of the chip holding stage 40 as the guide 44. Referring to FIG. 8B, a convex portion surrounding the rubber collet 42 in a continuous manner may be arranged as the guide 44. In this case, the semiconductor chip 4 is accommodated in the convex portion. The guide 44 may not surround the semiconductor chip 4 from four sides of the semiconductor chip 4. It is only necessary that the guide 44 restrict the movement of the semiconductor chip 4 in a direction parallel to or substantially parallel to the lower surface of the semiconductor chip 4, and allow the semiconductor chip 4 to be transferred in the vertical direction with high precision. In addition, a material other than rubber may be used as the material of the guide 44.

### FIFTH EMBODIMENT

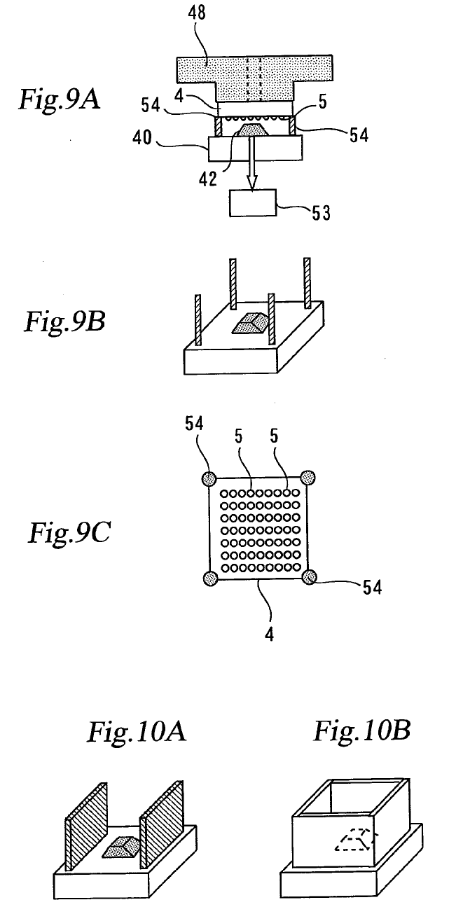

FIGS. 9A to 9C show a fifth embodiment of the present invention. The fifth embodiment is common to the fourth embodiment in that the fifth embodiment is characterized in a method for transferring the semiconductor chip to the bonding head. The fifth embodiment, however, is different from the fourth embodiment in a technique for holding the semiconductor chip.

As shown in FIG. 9A, the chip holding stage 40 and the rubber collet 42 (which are described in the fourth embodiment) are provided in an apparatus according to the fifth embodiment. Four rubber needles 54 are provided around the rubber collet 42 as shown in FIGS. 9A and 9B. The rubber needles 54 are in contact with portions (hereinafter also called non-bump-formed portions) of the lower surface (on which the bumps 5 are provided) of the semiconductor chip 4. The bumps 5 are not present on the portions of the lower surface of the semiconductor chip 4. In the present embodiment, the four rubber needles 54 are respectively located in the vicinities of four corners of the rubber collet 42 such that the rubber needles 54 hold four corners of the semiconductor chip 4.

FIG. 9C is a diagram showing the semiconductor chip 4 when the semiconductor chip 4 and the rubber needles 54 are viewed from the lower side of the drawing sheet of FIG. 9A. The four rubber needles 54 are in contact with the four corner of the semiconductor chip 4, respectively. The lengths of the rubber needles 54 are set such that the bumps 5 are not in contact with the rubber collet 42 when the rubber needles 54 hold the semiconductor chip 4.

A negative pressure generation mechanism 53 is provided under the chip holding stage 40. The negative pressure generation mechanism 53 generates negative pressure in a space located under the chip holding stage 40 to generate a suction force that acts on the semiconductor chip through the through holes. The semiconductor chip 4 can be sucked by the generated suction force toward a direction indicated by an arrow shown in FIG. 9A.

As shown in FIG. 9A, the bonding head 48 holds the semiconductor chip 4 in the fifth embodiment.

### [Operations of Apparatus According to Fifth Embodiment]

In the fifth embodiment, the negative pressure generation mechanism 53 generates a suction force in the direction indicated by the arrow shown in FIG. 9A under the condition that the semiconductor chip 4 is held by the rubber needles 54. The semiconductor chip 4 is sucked toward the lower side of the drawing sheet by the generated suction force and fixed at a position shown in FIG. 9A.

The bonding head 48 vacuum-sucks the semiconductor chip 4 to receive the semiconductor chip 4 under the condition that the bonding head 12 is in contact with the semiconductor 4 as shown in FIG. 9A. As described above, the semiconductor chip 4 is held while the bumps 5 are not in contact with the rubber collet 42. Therefore, a failure such as collapse of the bumps 5 does not occur even when the bumps 5 are melted due to the contact of the bonding head 12 having a high temperature with the semiconductor chip 4.

According to the fifth embodiment, the rubber needles 54 effectively use the corner portions of the lower surface (on which the bumps are provided) of the semiconductor chip 4 to hold the semiconductor chip 4. Since each of the rubber needles 54 has elasticity, the rubber needles 54 can effectively prevent the semiconductor chip 4 from being broken during the transfer of the semiconductor chip 4.

When the semiconductor chip 4 is transferred to the bonding head 48, the temperature of the semiconductor chip 4 immediately increases, and the bumps 5 of the semiconductor chip 4 are melted. After that, bonding is performed in the same manner as in the first to third embodiments. A time required to increase the temperature of the heater can be reduced in the same manner as in the first to third embodiments since the process of bonding the semiconductor chip 4 can be performed under the condition that the bumps 5 are in the molten state.

The fourth and fifth embodiments are different from each other in that the bumps are not in contact with any other object at the start time of the transfer of the semiconductor chip in the fifth embodiment, while the bumps are in contact with the rubber collet 42 at the start time of the transfer of the semiconductor chip in the fourth embodiment.

### MODIFIED EXAMPLE OF FIFTH EMBODIMENT

A support member such as members shown in FIGS. 10A and 10B may be replaced with the rubber needles 54. In addition, a member made of a material other than rubber may be replaced with the rubber needles 54.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2007-298500, filed on Nov. 16, 2007 including specification, claims, drawings and summary, on which the Convention priority of the present application is based, are incorporated herein by reference in its entirety.

1. An apparatus manufacturing a semiconductor device, comprising:
a bonding head capable of holding a first bonding object to be bonded;
a stage capable of mounting thereon a second bonding object to be bonded to the first bonding object;
a heater provided in at least one of the bonding head and the stage;
temperature control means for controlling an output of the heater to cause the heater to radiate heat in order that the temperature of the bonding object that is in contact with the at least one of the bonding head and the stage is equal to or more than the melting point of a bump material, the at least one of the bonding head and the stage having the heater therein;
measurement means for performing a measurement on the first and second bonding objects under the condition that the bonding head holds the first bonding object and the stage has the second bonding object mounted thereon and before the first and second bonding objects are bonded to each other through bumps;
determination means for determining the amount of a reduction in a distance between a contact surface of the bonding head and a mounting surface of the stage based on the result of the measurement performed by the measurement means; and
position control means that is controlled by the determined means under the condition that the temperature control means controls the heater to cause the heater to radiate the heat, and that causes the bonding head and the stage to come close to each other in order to ensure that the first bonding object is bonded to the second bonding object via the bumps, from the state where the first and second bonding objects are separated from each other and the bonding head faces the stage.

2. The apparatus according to claim 1,
wherein the measurement means has optical detection means for detecting light coming from the first and second bonding objects.

3. The apparatus according to claim 2, wherein
the optical detection means has a camera for capturing an image of a gap between the first and second bonding objects under the condition that the bonding head faces the stage such that the first and second bonding object are separated from each other, and
the determination means determines the amount of the reduction in the distance based on the result of the image capture performed by the camera.

4. The apparatus according to claim 2,
wherein the optical detection means has:
a head-side laser displacement meter capable of emitting a laser beam onto a surface of the first bonding object to measure the thickness of the first bonding object, the surface of the first bonding object being to be bonded to the second bonding object; and
a stage-side laser displacement meter capable of emitting a laser beam onto a surface of the second bonding object to measure the thickness of the second bonding object, the surface of the second bonding object being to be bonded to the first bonding object, and
wherein the determination means calculates the amount of the reduction in the distance based on the result of the measurement performed by the head-side laser displacement meter and on the result of the measurement performed by the stage-side laser displacement meter.

5. A method for manufacturing a semiconductor device, comprising the steps of:
causing a bonding head having a heater to hold a semiconductor chip having a bump;
mounting a bonding object on a stage, the bonding object being to be bonded to the semiconductor chip;
melting the bump of the semiconductor chip included in the semiconductor chip by causing the heater to heat the semiconductor chip held by the bonding head;
measurement for performing a measurement on the semiconductor chip and the bonding object under the condition that the bonding head holds the semiconductor chip and the stage has the bonding object mounted thereon and before the semiconductor chip comes in contact with the bonding object; and
causing the bump melted in the melting step to come in contact with a bonding member of the bonding object under the condition that the bump is in a molten state by causing the bonding head and the stage to come close to each other based on the result of the measurement performed in the measurement step.

6. The method according to claim 5,
wherein the measurement step includes an optical detection step of detecting light coming from the semiconductor chip and the bonding object.

7. A method for manufacturing a semiconductor device, comprising the steps of:
preparing first and second bonding objects, at least one of the first and second bonding objects having a bump;
causing a bonding head to hold the first bonding object;
mounting the second bonding object on a stage;
melting the bump provided on the at least one of the first and second bonding objects by heating;
causing the first and second objects to come in contact with each other for bonding via the bump melted in the melting step by causing the bonding head and the stage to come close to each other; and
head separation for separating the bonding head from the bonding object under the condition the bump is in a molten state, after the contact step.

8. A method for manufacturing a semiconductor device, comprising the steps of:
preparing first and second bonding objects, at least one of the first and second bonding objects having a bump;
causing a bonding head to hold the first bonding object;
mounting the second bonding object on a stage;
causing the first and second bonding objects to come in contact with each other via the bump by causing the bonding head and the stage to come close to each other;
melting the bump by heating, after the contact step; and
head separation for separating the bonding head from the first bonding object under the condition that the bump is in a molten state, after the melting step.

9. A method for manufacturing a semiconductor device, comprising the steps of:
mounting a first bonding object having a bump on a stage having a heater;
causing a bonding head to hold a second bonding object;
melting the bump of the first bonding object by causing the heater to heat the first bonding object mounted on the stage; and
causing the bump melted in the melting step to come in contact with the second bonding object under the condition that the bump is in a molten state by causing the bonding head and the stage to come close to each other.

10. A method for manufacturing a semiconductor device,
wherein the method according to claim 5 is repeated a plurality of times under the condition that an output of the heater is maintained so as to allow the bump of the semiconductor chip to be melted.

11. A method for transferring a semiconductor chip, comprising the steps of:
holding a semiconductor chip having a bump under the condition that the bump is in contact with a chip holding member;
preparing a bonding head having a heater and capable of sucking the semiconductor chip to hold the semiconductor chip;
positioning the bonding head at a position at which a surface of the bonding head is separated by a predetermined distance from a non-bump-formed portion of a surface of the semiconductor chip held in the holding step; and
chip transfer for causing the bonding head to suck the semiconductor chip from the state where the surface of the bonding head is separated by the predetermined distance from the non-bump-formed portion of the surface of the semiconductor chip held in the holding step.

12. The method according to claim 11, wherein
in the holding step, the semiconductor chip is held under the condition that the chip holding member has a convex portion surrounding the semiconductor chip in a continuous or discontinuous manner; and
in the chip transfer step, the semiconductor chip moves along a direction, in which the convex portion extends, and is sucked by the bonding head.

13. A method for transferring a semiconductor chip, comprising the steps of:
holding a portion of a semiconductor chip having a bump to hold the semiconductor chip, the bump being not present on the portion of the semiconductor chip;
preparing a bonding head having a heater; and
chip transfer for causing the bonding head to receive the semiconductor chip held in the holding step.

14. The method according to claim 13,
wherein, in the holding step, a corner of a surface of the semiconductor chip is held by a column-shaped member, the bump being provided on the surface of the semiconductor chip.

15. A method for manufacturing a semiconductor device, comprising the steps of:
the chip transfer according to claim 11; and
bonding the semiconductor chip received by the bonding head in the chip transfer step to a bonding object via the bump of the semiconductor chip.

16. A method for manufacturing a semiconductor device, comprising the steps of:
the chip transfer according to claim 13; and
bonding the semiconductor chip received by the bonding head in the chip transfer step to a bonding object via the bump of the semiconductor chip.
